(19) United States
(12) Patent Application Publication
(10) Pub. No.: US 2014/0156234 A1
(43) Pub. Date: Jun. 5, 2014

(54) INPUT OUTPUT CLONING FOR INDUSTRIAL AUTOMATION

(71) Applicant: ROCKWELL AUTOMATION TECHNOLOGIES, IN, Mayfield Heights, OH (US)

(72) Inventors: Francisco Maturana, Lyndhurst, OH (US); Kenwood Hall, Hudson, OH (US)

(73) Assignee: ROCKWELL AUTOMATION TECHNOLOGIES, INC.,, Mayfield Heights, OH (US)

(21) Appl. No.: 13/692,884

(22) Filed: Dec. 3, 2012

(51) Int. Cl. G06F 17/50

(52) U.S. Cl. CPC G06F 17/5009
USPC 703/2

(57) ABSTRACT

Methods and systems for creating and running and industrial control system simulation are described herein. The physical I/O and other modules of the industrial control system may be modeled and specific communication channels may be created by a modeling software module. This may increase the likelihood that the timing of the simulation may be more like real-time operation of the industrial control system. This may enhance the system design and save time of system design and start-up and troubleshooting of the operational industrial control system.

### TECHNICAL BACKGROUND

In many industrial environments the quantity and complexity of equipment used requires automation in order to make productive use of the equipment. Automation system design is enhanced by simulation of the operation of the industrial automation processor and inputs and outputs (I/O).

Often timing is very important to the actual operation of the industrial system. A simulation with timing as close to real-time as possible would enhance the design and programming of the industrial system.

### OVERVIEW

In various embodiments, methods and systems for creating and running and industrial control system simulation are described herein. The physical I/O and other modules of the industrial control system may be modeled, and specific communication channels may be created by a modeling software module. This may reduce delays within the system and software of the simulation, thereby increasing the likelihood that the timing of the simulation may be more like real-time operation of the industrial control system. Other techniques are described to compensate for these system delays. This may enhance the system design and save time of system design and start-up and troubleshooting of the operational industrial control system.

This overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

FIG. 1 illustrates a software system for creating and operating an industrial system simulation.

FIG. 2 illustrates an example of a system capable of creating and operating an industrial system simulation.

FIG. 3 illustrates a flow chart of a method of for creating an industrial system simulation.

FIG. 4 illustrates a block diagram of a computer system configured to operate as a computer in an industrial system simulation.

FIG. 5 illustrates a block diagram of a computer system configured to operate as a computer/workstation in an industrial system simulation.

### DETAILED DESCRIPTION

The following description and associated drawings teach the best mode of the invention. For the purpose of teaching inventive principles, some conventional aspects of the best mode may be simplified or omitted. The following claims specify the scope of the invention. Some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by claims and their equivalents.

Industrial control systems may be large and complex in their size and speed at which they operate. Simulation of the system may be desirable before the system is started up to minimize problems associated with startup and operation of a complex industrial control system.

Simulations using the actual inputs, outputs, and other module from the industrial control system may provide a better simulation, because the actual control system I/O and timing are used. Problems may arise with the timing of the simulation and operation of the actual industrial control system.

The present disclosure describes a method, system, and apparatus for creating and executing a simulation of an industrial control system. The physical I/O of the industrial control system may be modeled, and specific communication channels may be created by a modeling software module during simulation creation. This may increase the likelihood that the timing of the simulation may be more like real-time operation of the industrial control system. This may enhance the system design and save time of system design and start-up and troubleshooting of the operational industrial control system.

In an example, C-code generation is used and the executable is built in a Windows workstation. A multi threaded infrastructure allows the instantiation of a collection of module entries for holding the characteristics of the I/O configuration that are specific to the data type I/O in the industrial control system. The I/O based module entries are registered in a rack based appliance via remote xml execution. The I/O module entries are threaded clones/models of the I/O in the appliance memory. A module entry synchronization kernel permits the coordination of the data transmission between the clones and the server level I/O module entries via a multi channel transmission control protocol and/or user data protocol (TCP/UDP) connection array. The TCP/UDP channels are dynamically formed and independently executed as separate threads. The synchronization kernel uses a channel interface processor (CIP)-based adapter to communicate with the controllers, which could be local to the control system rack or remotely located.

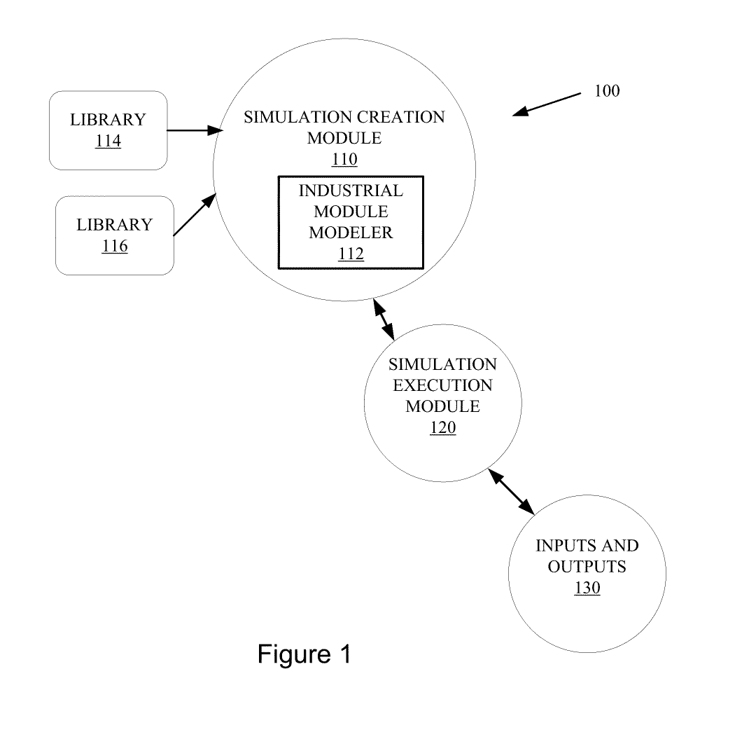

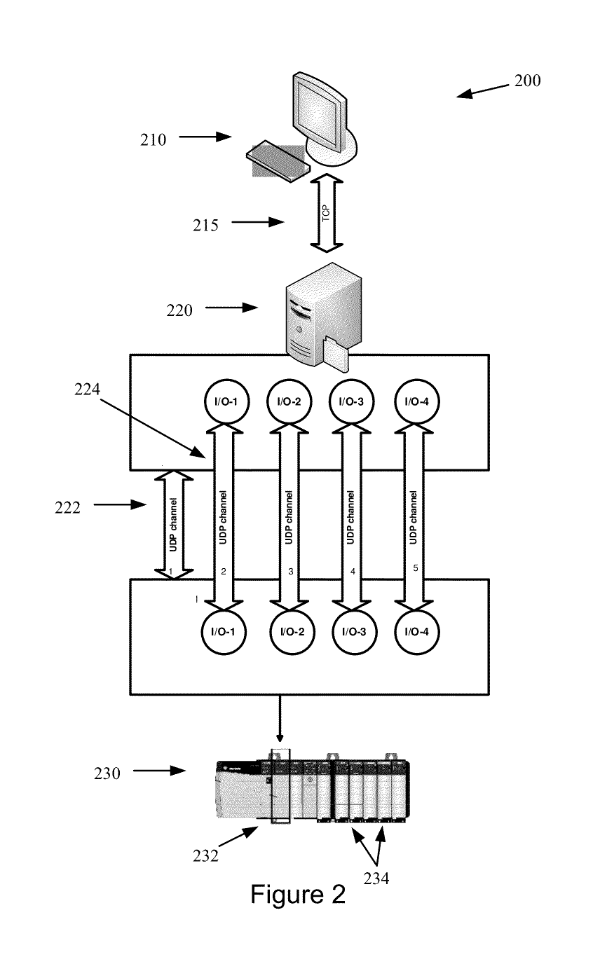

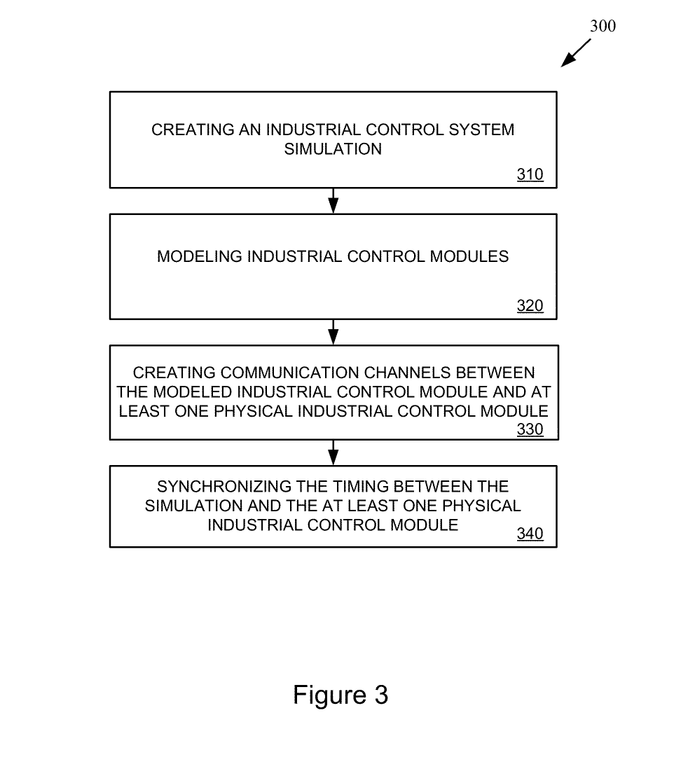

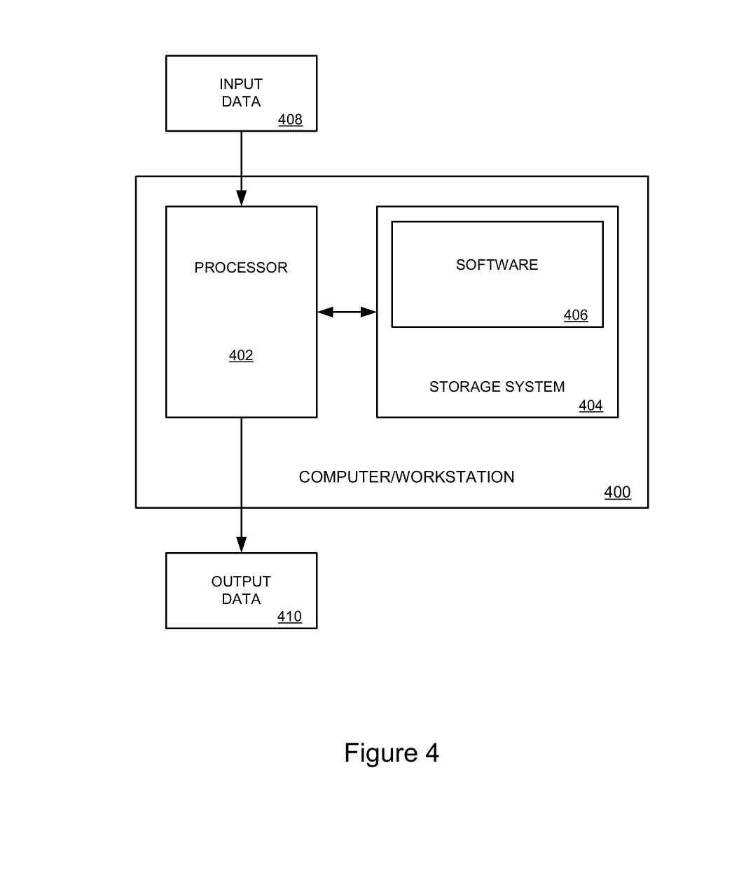

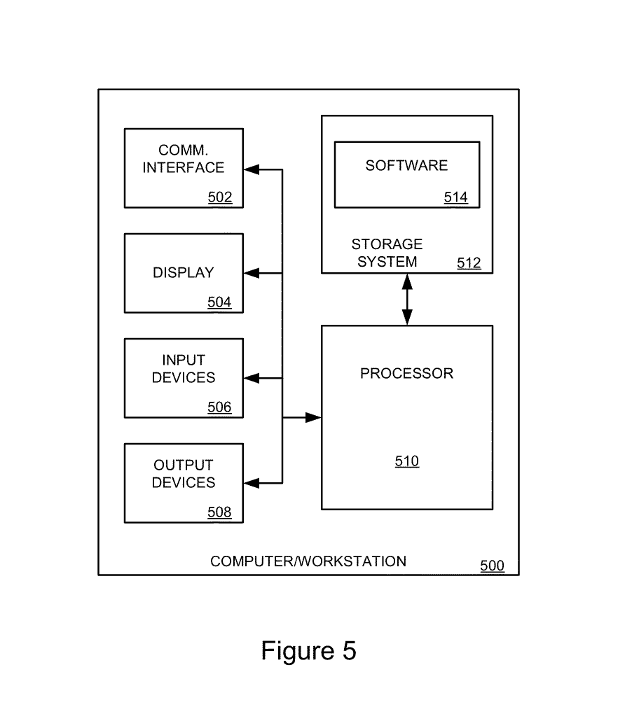

FIG. 1 illustrates a software system for creating and operating an industrial system simulation. FIG. 2 illustrates an example of a system capable of creating and operating an industrial system simulation. FIG. 3 illustrates a flow chart of a method of for creating an industrial system simulation. FIG. 4 illustrates a block diagram of a computer system configured to operate as a computer in an industrial system simulation. FIG. 5 illustrates a block diagram of a computer system configured to operate as a computer/workstation in an industrial system simulation.

Referring now to FIG. 1, illustrated is an example software system 100, which includes modules 110, 120, 130 which, along with libraries 114 and 116, may be configured to accomplish creating and/or operating an industrial system simulation when used with a computing apparatus.

Simulation creation module 110 is capable of creating an industrial control system simulation. The simulation may include modeling and/or cloning industrial control system inputs, outputs, and/or other modules which may be used within and industrial control system.

Simulation creation module 110, includes industrial module modeler 112, which is configured to model inputs, outputs, and other functionality of an industrial control system. Industrial module modeler 112 may include a collection of module entries for holding the characteristics of I/O configuration that are specific to the data type I/O and other modules in the industrial control system. Industrial module modeler 112 may be preconfigured to allow mapping, modeling and/or cloning of the physical modules within the industrial control system.

Industrial module modeler 112 may also create communication channels, within an executable simulation, with the input, output, and other modules within the industrial control modules. These multiple communication channels may enhance the likelihood of synchronization of the simulation with the module in the industrial control system. The I/O module specific configuration and multiple preconfigured communication channels may enhance the legitimacy of the simulation and increase the synchronization of the simulation with the actual inputs, outputs, and other module within the industrial control system.

Simulation creation module 110 may also use libraries 114 and 116 when creating the simulation. Libraries and their use may be somewhat common when software is used to create executable systems. Libraries 114 and 116 may be operable in different operating systems/software systems, such as Windows, Linux, C, C++, etc. The use of a Windows-based operating system and C++ may enable the user to enhance the creation and execution of a simulation using an industrial control system.

Simulation creation module 110 may be used to create and executable program, which is capable of be instantiated/executed by simulation execution module 120. Execution module 120 may receive an executable program from creation module 110, and communicate with inputs and/or outputs 130 of an industrial control system to run the simulation with inputs and/or outputs 130.

In an example, simulation creation module 110 may reside on a Windows workstation where a user may use the workstation and simulation creation module 110 to program/create the simulation executable program. Simulation executable module 120 may reside on another workstation configured to execute/run the executable in cooperation with an industrial control system, which may include inputs and/or outputs 130.

The industrial control system may be a programmable logic controller (PLC)-type system which includes a processor and interchangeable modules for input/outputs and other control system components. The industrial control system may also include a simulation module which may facilitate the running of simulation and communication with the executable program and the industrial control processor and input/output modules.

It will be appreciated that creation module 110 and execution module 120 may be within the same module and reside on the same computer location and/or workstation. Furthermore, these modules and their functionality may be accomplished on any one or combination of the different processors/computers/systems in this non-limiting example.

FIG. 2 illustrates an example system 200 capable of creating and/or operating an industrial system simulation. System 200 includes a workstation 210, an executing workstation 220, and an industrial control system 230. System 200 further includes a communication channel/link 215 capable of transferring communication between workstation 210 and executing workstation 220. Similarly, system 200 includes communications channels 222, and 224 which are capable of carrying communications between executing workstation and industrial control system 230.

Workstation 210 is capable of having software stored therein, which, if executed may enable a user to create and/or operate an industrial system simulation. Workstation 210 may have stored therein the simulation creation module 110, and have access to libraries 114 and 116. A user may use workstation 210 to model/simulate an industrial control system and/or an industrial plant in which the control system is a part. Simulation creation module 110 may then be used to create an executable simulation file/program.

In this example, system 200 also includes an execution workstation 220 communicatively linked to workstation 200 via communication channel 215. Communication channel may be a transmission control protocol (TCP), Internet protocol (IP) connection, or any other wired and/or wireless communication link, capable of allowing communications between the workstations.

Execution workstation 220 receives the executable file/program from workstation 210. Execution workstation 220 includes simulation execution module 120, which is capable of running the simulation.

Execution workstation 220 may also be communicatively linked to industrial control system 230 via one or more communication links 222, 224. Industrial control system 230 includes a processor, input, output, and other modules 234 in a rack mount-type industrial control system.

Industrial control system 230 is programmed using ladder-logic type programming, which is referred to herein as an industrial control program. The industrial control program is typically stored in memory of the industrial control system 230, and executed by the industrial control processor module.

Industrial control system 230 also includes a simulation module 232 which is configured to assist in running the simulation, and communication with execution workstation 220, workstation 210, and/or other system. Simulation module 232 may also include a processor to aid the creation, execution, and/or any other step or process of the communication, creation, execution, or running of the simulation. Simulation module 232 is capable of running/instantiating any of the software described herein, in particular the software described in FIG. 1.

In this example communication link 222 is a user data protocol (UDP) channel. Channel 222 may be used for the exchange of data including xml-type I/O configuration information between the executable simulation on executable workstation 220 and industrial control system 230.

Communication link(s) 224 may also be UDP-type communication links, which may be configured to communicate relatively more quickly with the actual, physical I/O and other industrial control modules 234 of the industrial control system 230. Channels 224 are independent UDP channels for the exchange of data between I/O modules and the simulation program.

These specific communication link(s) may increase the likelihood that the timing and/or simulation are closer to the actual running of the industrial control system. This may aid in designing and implementing industrial control systems.

It will be appreciated that portions and/or all of the simulation creation and execution may be accomplished on workstation 210, execution workstation 220, simulation module 232, and/or the processor in industrial control system 230, and/or other processing system. Furthermore, portions and/or all of the simulation creation and execution software may reside on workstation 210, execution workstation 220, simulation module 232, and/or the processor in industrial control system 230, and/or other processing system. One or more of the workstations may be eliminated and all functionality disclosed herein may be accomplished on one or more processors.

Other aspects of the timing of the simulation to be considered in this architecture are the latencies associated with the various communication between the computers and simulation. This includes the latencies induced by the network, between the application running in the workstation and the system simulation, and between the server running the interface program and the backplane of the industrial control system.

The following includes methods of compensating for these timing discrepancies. Synchronization involves a multi-objective optimization problem, where two variables need to be optimized. They are the execution time and the update rate. This leads to the following requirements to be established.
1) Tₛᵢₘᵤₗₐₜᵢₒₙ−T_{appliance}≈0, these times are never equal but they get very similar (per simulation node basis)
2) UR_{Actual}−UR_{Apparent}=UR_{Error}=0, per module entry basis where,

$${{UR}_{Apparent}}_{basis} = \frac{1}{m} {\sum }_{i}^{m} {TimestampT}_{i} - \frac{1}{l} {\sum }_{j}^{l} {TimestampP}_{j} ,$$

per module entry

Conditions for Objective 1

In an example, the simulation execution speed can be controlled by means of real time interrupts controlling the acceleration rate. Since it is a fixed step simulation, the system can be programmed to wait a couple of cycles to let the controller advance one time step, or the simulation could be run a number of times in a simulation cycle to allow it to “catch up” with the controller's time. To do this a real time timer on the windows workstation is needed. This timer will produce the interrupts for controlling the acceleration rate.

Conditions for Objective 2

Each module entry will need its update rate adjusted according to a central timestamp observer. So

IF UR_{Error}>0 THEN
: decrease module entry's update rate by one half of the total error

ELSE IF UR_{Error}<0 THEN
: increase module entry's update rate by one half of the total error

ELSE
Do nothing

FIG. 3 illustrates a flow chart of an example method of synchronizing a simulation and physical inputs, outputs, or other industrial control system modules (300). Various operations of this method may be performed by one or more processing systems, and there is no need to tie any operation to any specific processing system as general purpose computers/processors may be configured to operate as systems capable of performing the operations of the method described herein.

Method 300 includes creating and industrial control system simulation 310, modeling industrial control modules 320, creating communication channels 330, and synchronizing the timing 340. Creating and industrial control system simulation 310 may include using simulation creation module 110. Creating and industrial control system simulation (310) includes modeling industrial control modules 320.

Modeling industrial control modules 320 is accomplished at least in part with industrial module modeler 112. When the simulation is created industrial module modeler 112 is used to create a model/clone of the physical I/O and other modules 234 located in the industrial control system 230. When the model of the I/O is included in the simulation, or when the simulation is instantiated, communication channels are created between the modeled industrial control module in the simulation and the actual industrial control module 234 in industrial control system at step 330.

When the simulation is executed, the created communication channels enhance the synchronization of the timing between the simulation and the physical industrial control modules at 340.

It will be appreciated that portions and/or all of method 300 and related software may be accomplished on workstation 210, execution workstation 220, simulation module 232, and/or the processor in industrial control system 230, and/or other processing system.

Referring now FIG. 4, a computer/processor/workstation system 400 and the associated discussion are intended to provide a brief, general description of a suitable computing environment in which the software modules in FIG. 1, and the process illustrated in FIG. 3 may be implemented. Many other configurations of computing devices and software computing systems may be employed to implement a system for creating and operating an industrial simulation system.

Computer/processor/workstation system 400 may be any type of computing system capable of creating and/or operating an industrial system simulation, such as a server computer, client computer, internet appliance, PLC, rack-type processor, or any combination or variation thereof. FIG. 5, discussed in more detail later, provides a more detailed illustration of an example workstation. Indeed, computer/processor/workstation system 400 may be implemented as a single computing system, but may also be implemented in a distributed manner across multiple computing systems. For example, computer/processor/workstation system 400 may be representative of a server system (not shown) with which the computer systems (not shown) running software 401 may communicate to enable computer aided design features. However, computer/processor/workstation system 400 may also be representative of the computer systems that run software 406. Indeed, computer/processor/workstation system 400 is provided as an example of a general purpose computing system that, when implementing software modules in FIG. 1, and the process illustrated in FIG. 3, becomes a specialized system capable of creating and/or operating an industrial system simulation.

Computer/workstation system 400 includes processor 402, storage system 404, and software 406. Processor 402 is communicatively coupled with storage system 404. Storage system 404 stores simulation software 406 which, when executed by processor 402, directs computer/processor/workstation system 400 to operate as described for the method illustrated in FIG. 3 and/or operate the software modules in FIG. 1.

Referring still to FIG. 4, processor 402 may comprise a microprocessor and other circuitry that retrieves and executes simulation software 406 from storage system 404. Processor 402 may be implemented within a single processing device but may also be distributed across multiple processing devices or sub-systems that cooperate in executing program instructions. Examples of processor 402 include general purpose central processing units, application specific processors, PLC processor modules, simulation module processors, and graphics processors, as well as any other type of processing device.

Storage system 404 may comprise any storage media readable by processor 402 and capable of storing any portion or all of simulation software 406. Storage system 404 may include volatile and nonvolatile, removable and non-removable media implemented in any method or technology for storage of information, such as computer readable instructions, data structures, program modules, or other data. Storage system 404 may be implemented as a single storage device but may also be implemented across multiple storage devices or sub-systems. Storage system 404 may comprise additional elements, such as a controller, capable of communicating with processor 402.

Examples of storage media include random access memory, read only memory, magnetic disks, optical disks, and flash memory, as well as any combination or variation thereof, or any other type of storage media. In some implementations, the storage media may be a non-transitory storage media. In some implementations, at least a portion of the storage media may be transitory. It should be understood that in no case is the storage media a propagated signal.

Simulation software 406 comprises computer program instructions, firmware, or some other form of machine-readable processing instructions, and/or combinations thereof, having at least some portion of software modules in FIG. 1, and the process illustrated in FIG. 3 embodied therein. Simulation software 406 may be implemented as a single application but also as multiple applications. Simulation software 406 may be a stand-alone application but may also be implemented within other applications distributed on multiple devices, including but not limited to other design software and operating system software.

In general, simulation software 406 may, when loaded into processor 402 and executed, transform processor 402, and computer/processor/workstation system 400 overall, from a general-purpose computing system into a special-purpose computing system customized to aid in the creation, execution, and/or running of the industrial system simulation as described by the software modules in FIG. 1, and the process illustrated in FIG. 3 and its associated discussion.

Encoding simulation software 406 may also transform the physical structure of storage system 404. The specific transformation of the physical structure may depend on various factors in different implementations of this description. Examples of such factors may include, but are not limited to: the technology used to implement the storage media of storage system 404, whether the computer-storage media are characterized as primary or secondary storage, and the like.

For example, if the computer-storage media are implemented as semiconductor-based memory, simulation software 406 may transform the physical state of the semiconductor memory when the software is encoded therein. For example, simulation software 406 may transform the state of transistors, capacitors, or other discrete circuit elements constituting the semiconductor memory.

A similar transformation may occur with respect to magnetic or optical media. Other transformations of physical media are possible without departing from the scope of the present description, with the foregoing examples provided only to facilitate this discussion.

Through the operation of computer/processor/workstation system 400 employing simulation software 406, transformations are performed on input data 408, resulting in output data 410. As an example, input data 408 could be considered transformed from one state to another by the transformation of various elements of simulation data contained therein.

Computer/processor/workstation system 400 may have additional devices, features, or functionality. Computer/processor/workstation system 400 may optionally have input devices such as a keyboard, a mouse, a voice input device, or a touch input device, and comparable input devices. Output devices such as a display, speakers, printer, and other types of output devices may also be included.

Computer/processor/workstation system 400 may also contain communication connections and devices that allow computer/processor/workstation system 400 to communicate with other devices, such as over a wired or wireless network in a distributed computing and communication environment. These devices are well known in the art and need not be discussed at length here. Examples of computer/processor/workstation system 400 may be a PLC processor, a processor in simulation module 232, workstations 310, and 320.

FIG. 5 illustrates a block diagram of a computer system configured to operate as a workstation 500. The software modules in FIG. 1, and the process illustrated in FIG. 3 may be implemented on one or more workstations 500, as shown in FIG. 5. Workstation 500 includes communication interface 502, display 504, input devices 506, output devices 508, processor 510, and storage system 512. Processor 510 is linked to communication interface 502, display 504, input devices 506, output devices 508, and storage system 512. Storage system 512 includes a non-transitory memory device that stores operating software 514.

Communication interface 502 includes components that communicate over communication links, such as network cards, ports, RF transceivers, processing circuitry and software, or some other communication devices. Communication interface 502 may be configured to communicate over metallic, wireless, or optical links. Communication interface 502 may be configured to use TDM, IP, Ethernet, optical networking, wireless protocols, communication signaling, or some other communication format—including combinations thereof.

Display 504 may be any type of display capable of presenting information to a user. Displays may include touch screens in some embodiments. Input devices 506 include any device capable of capturing user inputs and transferring them to workstation 500. Input devices 50 may include a keyboard, mouse, touch pad, or some other user input apparatus. Output devices 508 include any device capable of transferring outputs from workstation 500 to a user. Output devices 508 may include printers, projectors, displays, or some other user output apparatus. Display 504, input devices 506, and output devices 508 may be external to workstation 500 or omitted in some examples.

Processor 510 includes a microprocessor and other circuitry that retrieves and executes operating software 514 from storage system 512. Storage system 512 includes a disk drive, flash drive, data storage circuitry, or some other non-transitory memory apparatus. Operating software 514 includes computer programs, firmware, or some other form of machine-readable processing instructions. Operating software 514 may include an operating system, utilities, drivers, network interfaces, applications, or some other type of software. When executed by processing circuitry, operating software 514 directs processor 510 to operate workstation 500 according to software modules in FIG. 1, and the process illustrated in FIG. 3.

In this example, workstation 500 executes a number of methods stored as software 514 within storage system 512. The results of the simulation design, creation, and implementation are displayed to a user via display 504, or output devices 508. Input devices 506 allow users to input a variety of data required by the industrial control system simulation.

For example, processor 510 receives input data 408 either from communication interface 502, input devices 506, or storage system 512. Processor 510 then operates on input data 408 to produce output data 410 which may be stored in storage system 512, displayed on display 504, or output through output devices 508.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A computer apparatus comprising software that when executed by the computer apparatus directs the apparatus to simulate operation of an industrial system; the software comprising:
simulation configuration software, that when executed by the computer apparatus directs the apparatus to create a simulation of an industrial control system, and a simulation executable file;
simulation execution software that when executed by the computer apparatus directs the apparatus to receive the simulation executable file from the simulation creation software, and execute the simulation executable file to run a simulation;
communication software that when executed by the computer apparatus directs the apparatus to communicate with the simulation execution software to assist in running the simulation, and to further communicate with at least one industrial control module; and
a non-transitory computer readable storage medium having the user simulation configuration software, the simulation execution software, and the communication software stored thereon.

2. The apparatus of claim 1, wherein the simulation configuration software comprises an industrial module modeler software configured to model the at least one industrial control module for the simulation.

3. The apparatus of claim 2, wherein the industrial module modeler software is configured to establish communication links between the simulation and the at least one industrial control module.

4. The apparatus of claim 1, wherein the simulation creation software and/or the simulation execution software is configured to synchronize the timing between the simulation and the at least one industrial control module.

5. The apparatus of claim 1, wherein at least a portion of the simulation configuration software, the simulation execution software, and the communication software is instantiated on a simulation module configured to assist in the running of the simulation.

6. A system for simulation of an industrial automation system, comprising:
a workstation configured to create a simulation of an industrial control system, create a simulation executable file based on the simulation, and execute the simulation executable file to run the simulation;
an industrial control system capable of sending and receiving data related to the running simulation on the workstation, and controlling physical industrial control modules within the industrial control system based at least in part on the running simulation;
wherein the creating the simulation comprises modeling the industrial control module and creating communication links between the modeled industrial control module and the physical industrial control module.

7. The system of claim 6, wherein the industrial control system comprises one or more physical industrial control modules.

8. The system of claim 7, wherein the creating a simulation of an industrial control system comprises modeling the one or more industrial control modules, and creating communication links between the modeled industrial control module and the physical industrial control module.

9. The system of claim 6, wherein the industrial control system comprises a simulation module configured to assist in the running of the simulation, and configured to send and receive data related to the running simulation.

10. The system of claim 6, further comprising an execution workstation configured to receive the simulation executable file and execute the simulation executable file to run the simulation, and wherein the industrial control system is configured to send and receive data related to the running simulation on the execution workstation.

11. The system of claim 10, wherein the communication between the workstation and executable workstation comprises TCP-type communication.

12. The system of claim 10, wherein the communication between the execution workstation and industrial control system comprises one or more user data protocol-type communication links.

13. The system of claim 10, wherein the workstation and the execution workstation comprise Windows-based operating system.

14. A method for creating a simulation of an industrial automation system comprising:
creating a simulation of an industrial control system at least in part using a simulation creation module on a computer:
modeling industrial modules at least in part using the simulation creation module on a computer;
creating communication channels between the modeled industrial control module and a physical industrial control module at least in part using a simulation execution module; and
synchronizing the timing between the simulation and the physical industrial control module at least in part using the simulation execution module.

15. The method of claim 14, further comprising executing the simulation at least in part using the workstation and the physical industrial control module.

16. The method of claim 14, further comprising an industrial control system, which comprises the physical industrial control module.

17. The method of claim 14, wherein the creating a simulation is accomplished at least in part using C++ programming language.

18. The method of claim 14, wherein the modeling is accomplished at least in part using an industrial module modeler.

19. The method of claim 14, wherein the creating communication channels is accomplished at least in part using an industrial module modeler.

20. The method of claim 14, wherein the creating a simulation is accomplished at least in part using software libraries.
